(19) United States
(12) Patent Application Publication
(10) Pub. No.: US 2008/0023120 A1
(43) Pub. Date: Jan. 31, 2008

(54) Self Adhering Cover

(76) Inventors: Cynthia Sue Rochman, Wauwatosa, WI (US); Timothy Lewis Rochman, Wauwatosa, WI (US)

Correspondence Address: Cynthia Rochman;Timothy Rochman, 1620 Upper Parkway South, Wauwatosa, WI, 53213, US

(21) Appl. No.: 11/828,696

(22) Filed: Jul. 26, 2007

Related U.S. Application Data
(60) Provisional application No. 60/834,033, filed on Jul. 28, 2006.

(51) Int. Cl. B32B 37/10; B32B 7/12

(52) U.S. Cl. 156/60; 428/343

(57) ABSTRACT

A self-adhering tablecloth or similar article cover is formed from a flexible material having an adhesive applied to an underside thereof. The cover preferably is formed from an inexpensive, flexible material such as paper, plastic film or a non-woven material. Its upper surface may be plain or decorated such as by printing or lamination. The adhesive preferably is one that provides sufficient tack to retain the cover on the article but that allows relatively low-effort detachment of the cover from the article and clean removal of the adhesive from the article. It also should be releasable from the upper surface of the cover, hence permitting the cover material to be wound onto rolls. The cover may be applied to the article in one piece or as a number of separated or overlapping strips.

### CROSS REFERENCE TO RELATED APPLICATION

This application claims the benefit of U.S. provisional patent application Ser. No. 60/834,033 filed Jul. 28, 2206

### BACKGROUND OF THE INVENTION

1. Field of the Invention

The invention relates to article covers such as tablecloths and, more particularly, relates to a self-adhering article cover. The invention additionally relates to methods of making and using such an article cover.

2. Discussion of the Related Art

Tablecloths and other article covers are often used both indoors and outdoors to protect articles from spills and/or to prevent items such as food from being contaminated by the articles. In the case of tables such as picnic tables, the article cover typically takes the form of a reusable cover made of cloth or plastic or a disposable cover made of paper, plastic, or a nonwoven material.

Tablecloths and other article covers typically are simply laid on the article and held in place by their own weight, friction, and the weight of items placed on the article cover. The resulting limited retention forces can be insufficient to hold the cover in place on windy days, in which case the wind lifts the cover at least partially off the article, potentially spilling items on the cover.

Proposals have been made to alleviate this problem through the provision of a tablecloth having adhesive strips on the underside of the tablecloth at strategic locations such as the corners of the tablecloth. See, for example, U.S. Pat. No. 6,578,499 to Kroll. However, these tablecloths are expensive to manufacture. They also cannot be wound onto rolls and, therefore, are relatively cumbersome to package and handle and expensive to store and ship. They are also only partially effective because the adhesive is applied to only portions of the tablecloth, leaving large portions of the cover free to move relative to the article. For example, the tablecloth may billow in the middle as wind flows upwardly through gaps between wooden boards or through metal mesh in the table.

The need therefore has arisen to provide a self-adhering tablecloth or similar article cover that is inexpensive to manufacture, reliable, and easy to use.

The need additionally has arisen to provide a self-adhering article cover that can be rolled upon itself to facilitate packaging, shipping, storage, handling, and application.

### SUMMARY OF THE INVENTION

In accordance with an aspect of the invention, at least some of the above-identified needs are met by providing a self-adhering tablecloth or similar article cover formed from a flexible material having an adhesive applied to an underside thereof. The cover preferably is formed from an inexpensive, flexible material such as paper, plastic film or a non-woven material. Its upper surface may be plain or decorated such as by printing or lamination. The adhesive preferably is one that provides sufficient tack to retain the cover on the article but that allows relatively low-effort detachment of the cover from the article and clean removal of the adhesive from the article. It also should be releasable from the upper surface of the cover, hence permitting the material of the cover to be wound onto rolls from which multiple covers may be dispensed. The cover may be applied to the article in one piece or as a number of separated or overlapping strips.

In accordance with other aspects of the invention, methods of making and using the cover are provided.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings, in which like reference numerals represent like parts throughout, and in which:

FIG. 1 is a top plan view of a tablecloth constructed in accordance with a preferred embodiment of the invention and showing the tablecloth spread onto a table;

FIG. 2 is a bottom plan view of the tablecloth of FIG. 1;

FIG. 3 is a sectional end view of a strip of the tablecloth of FIGS. 1 and 2;

FIG. 4 is a perspective view of a rolled web from which the strip of FIG. 3 can be cut, and of a dispenser for the web; and

FIG. 5 is a schematic view of a system for manufacturing the roll illustrated in FIG. 4.

### DETAILED DESCRIPTION OF THE PREFERRED EMBODIMENTS

A preferred embodiment of the invention will now be described in the form of a tablecloth, it being understood that the invention is also applicable to other self-adhering removable article covers as well.

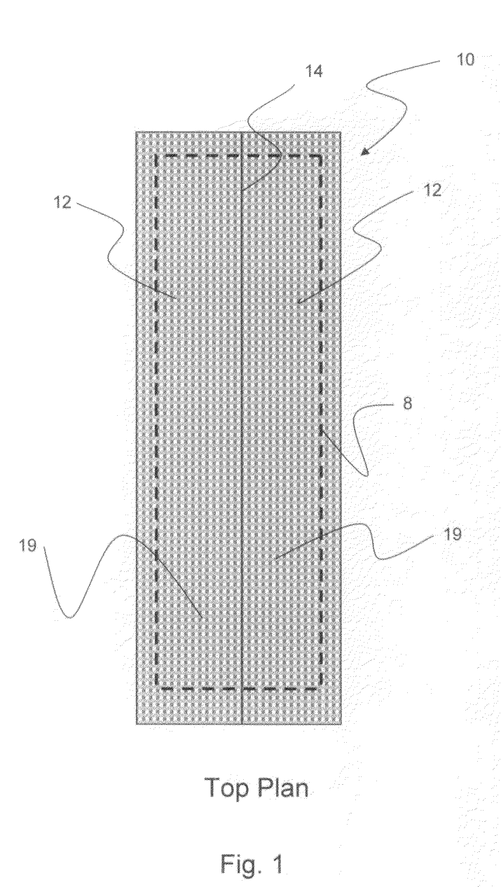

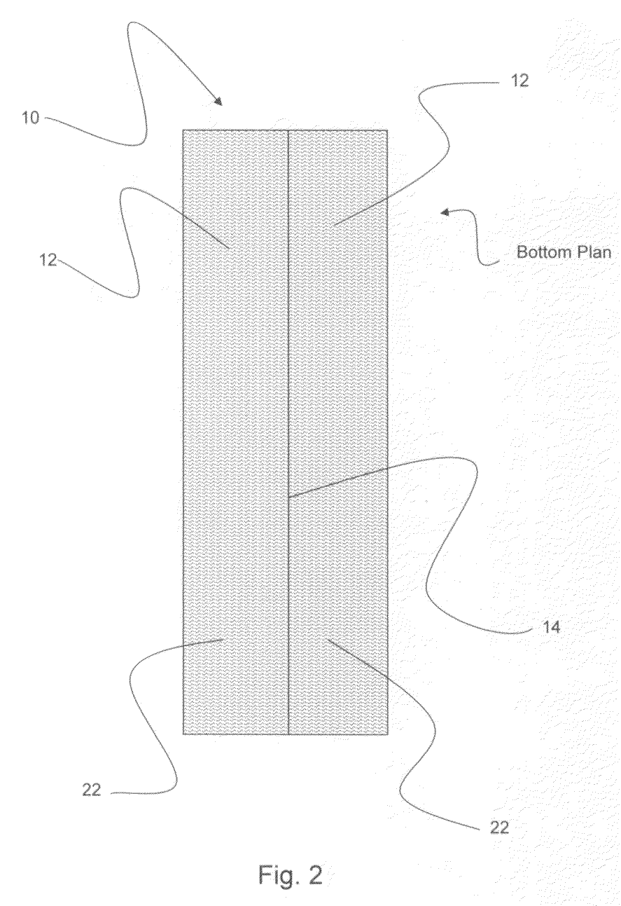

Referring initially to FIGS. 1-3, a tablecloth 10 is illustrated that covers the upper surface of a table 8 such as a picnic table or a patio table. The size and shape of the tablecloth 10 may vary from application to application. It may, for example, take the form of a 4′ diameter round cover or a 3′×6′ rectangular cover. The tablecloth 10 may be formed of a single pre-formed article of dimensions sufficient to cover the table. Alternatively, it could be formed from multiple strips of “standard” width and a user-specified length. The illustrated tablecloth 10 is configured to be used in a multi-strip application in which two or more parallel strips 12 are laid onto to the top of the table 8, preferably in an overlapping manner, with a seam 14 therebetween.

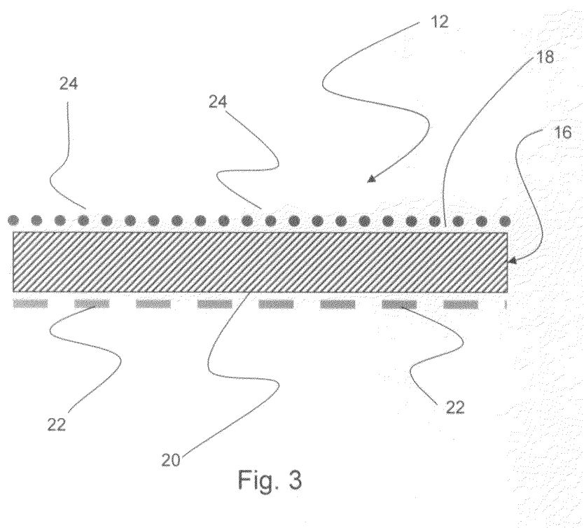

Referring to FIG. 3, each strip 12 of the tablecloth 10 is formed from a substrate 16 having upper and lower surfaces 18 and 20. An adhesive 22 is applied to the lower surface 20 of the substrate 16. Depending on the properties of the adhesive 22, the manner of applying the adhesive to the substrate, and the properties of the substrate 16, as well as the intended methods of packaging and use, a release coating 24 may also be applied to the upper surface 18 of the substrate 16.

Still referring to FIG. 3, the substrate 16 may be formed from any material capable of receiving the adhesive 22 on its bottom surface 20. It also preferably is sufficiently flexible to be wound onto a roll, unwound from the roll, and laid flat on a table with minimal effort. It should also be disposable. The substrate 16 may, for instance, comprise paper or a film formed from a polyolefin film such as polyester or polypropylene. It could also be formed from a nonwoven material such as a melt blown, spunbond, or needle punched material. The substrate 16 should be sufficiently thin to be windable on roll yet sufficiently thick to be durable. Depending on the characteristics of the material and on the application, a thickness of 0.5 mil. to 10 mil. is preferred, and a thickness of about 1.5 mil. to 2.5 mil. is especially preferred.

The upper surface 18 of the substrate 16 may be plain or may be decorated in any desired manner such as a pattern 19 (FIG. 1). Decoration may be applied, for example, by direct printing or silk screening. The decoration could also be applied by reverse printing and lamination to provide scuff resistance. As still another alternative, the material of the substrate 16 may itself can be pigmented in any of a variety of colors or patterns. Additionally, a decorated or undecorated nonwoven layer may be laminated to the upper surface 18 of a film substrate to impart a cloth-like feel to the tablecloth 10.

The adhesive 22 should be sufficiently tacky to hold the tablecloth 20 to typical table surfaces such as wood, glass, plastic, stone, or metal. However, it should not be so tacky that the tablecloth 10 cannot be easily removed from the table 8. It preferably is stronger in sheer than in peel to promote a secure hold to the table 8 while permitting the tablecloth 10 to be easily removed form the table 8 after use by simply peeling the tablecloth 10 from the table 8. The adhesive 22 also should also be one that minimizes post-removal cleaning of the table. It preferably adheres to the tablecloth 10 with greater strength than to the table so as to leave no residue. Even if some residue remains, the residue preferably is of the type that can be easily removed It should also be non-toxic and, even more preferably, food-grade. A variety of repositional materials similar to those used in the label technology industry are suitable for at least most of these purposes. These materials may be hot-melt or solvent based. For instance, they may be rubber based, Kraton® based, acrylic, SIS, SBS, or another block co-polymer.

The adhesive 22 should cover a sufficient portion of the lower surface 20 of the substrate 16 to assure that the entire tablecloth 10 adheres to the table 8. A continuous layer is, of course, ideal for this purpose, but may not be practical from an expense standpoint and may be difficult to remove from the tabletop after use. Therefore a discontinuous coating that covers a substantial portion of the surface area of the tablecloth 10 is preferred. Such coatings may, for example, be applied by spray coating, starved die, random fiberization, oriented fiberization, or other non-contact applications. These coatings may also be applied by contact methods such as roll, gravure, or print coating.

In the preferred embodiment in which the tablecloth 10 is wound onto a roll, release coating 24 preferably is applied to the upper surface 18 of the substrate 16 to prevent the web 30 (detailed below) from which the strips 12 of the tablecloth 10 are cut from sticking to itself when the web 30 is wound onto the roll. The release coating may, for example, comprise a silicone-based coating, a UV cured coating, a cross-linked coating, any of a variety of coatings used for label applications.

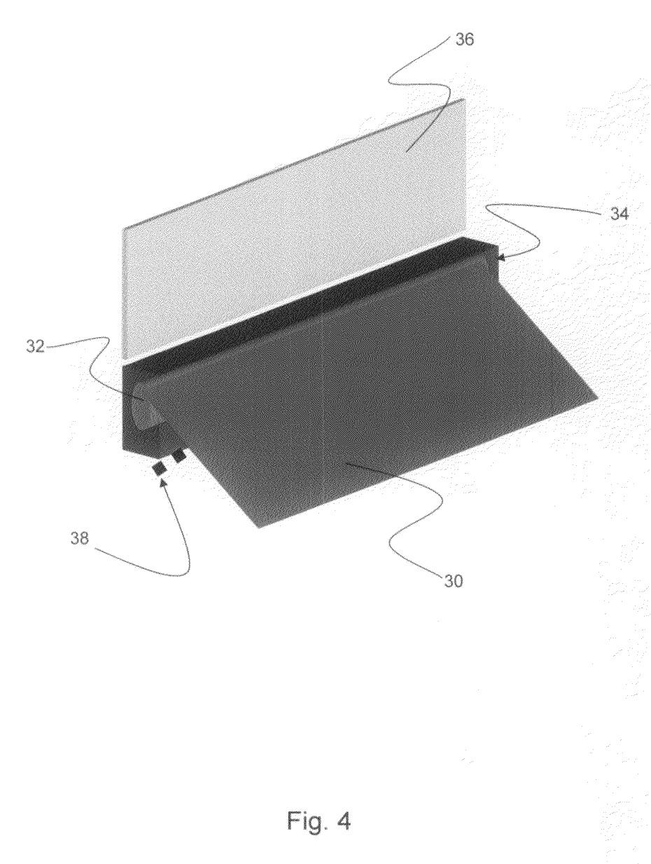

Referring to FIG. 4, the strips 12 are preferably cuttable from a web 30 wound onto a roll 32. The roll 32 is mounted in a dispenser 34 covered by a lid 36 and bearing a cutting device such as a cutting edge 38. The web 30 is wound onto itself with the adhesive 22 on the bottom surface and the release coating 24 on its upper surface. The web 30 can be unwound from the roll 32, cut to a desired length using cutting edge 38 to form a strip 12, and as many strips as are needed can then be pressed onto the table 8 to form the tablecloth 10. The adhesive 22 retains the tablecloth 10 on the table 8 during use by sticking to at least a substantial portion of the table's surface. After use, the tablecloth 10 can be peeled off the table 8 and disposed of. It can even be wrapped around trash on the table and used as a trash bag.

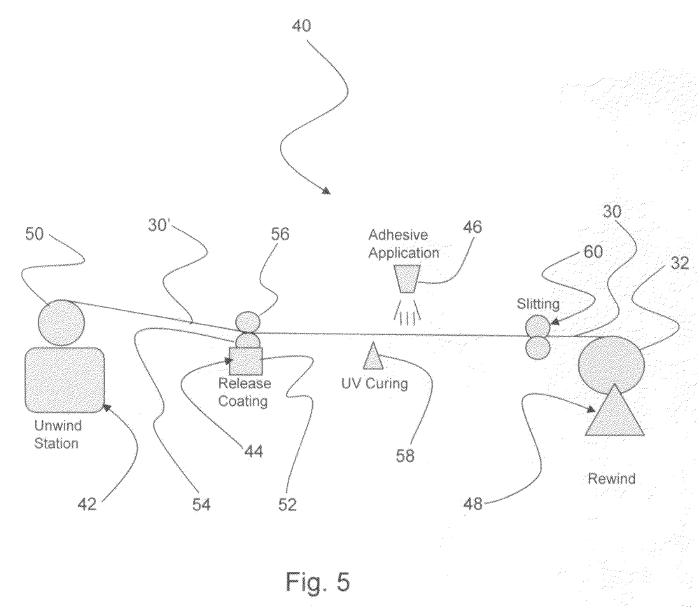

Referring to FIG. 5, a system 40 is illustrated that applies adhesive and a release coating to a web 30′ of the substrate to form the web 30 as described above in conjunction with FIG. 4. Reference characters from FIGS. 1-4, while not shown in FIG. 5, will also be referred to in order to facilitate an understanding of the relationship between the web 30′, the web 30, and the strips 12. The major components of system 40 include an unwind station 42, a release coating station 44, an adhesive application station 46, and a rewind station 48.

Still referring to FIG. 5, the unwind station 42 supports a roll 50 of substrate 16 from which the web 30′ is withdrawn under tension from the rewind station 48 and/or driven nip (not shown) and fed downstream through the system 40 with the upper surface 18 of the substrate 16 facing downward. (It should be noted that the upper surface 18 of the substrate 16 could face upward, in which case the release coating station 44 and related equipment would be located above the web 30′ and the adhesive application station 46 would be located beneath the web 30′) The upper surface 18 may be pre-decorated on its upper surface as described above. Alternatively, a decorating station (not shown) could be provided between the unwind station 42 and the release coating station 44.

With continued reference to FIG. 5, the release coating station 44 applies the release coating 20 to the downwardly facing upper surface 18 of the substrate 16. Release coating station 44 may comprise a basin 52 that stores a liquid release coating material and nip rollers 54 and 56 that draw the web 30′ through the release coating station 44 while transferring the release coating material to the web 30′. The release coating may be cured with a UV curing device 58 located downstream from the release coating station 44 in the direction of web movement. The adhesive application station 46 applies adhesive 22 to the bottom surface 24 of the substrate 16. The adhesive 22 may be applied by contact using a slot nozzle, rollers or the like or without contact by, for example, melt blowing or a Controlled Fiberization® spray application or any number of airless or air-assisted spray methods.

In the typical case in which the finished rolls 32 are less than 2′ wide and the bulk substrate of the web 30′ being unwound from the unwind station 42 is much wider (typically on the order of 6′ to 8′), the web 30′ can be slit to the desired widths of webs 30 using slitters 60 spaced along the width of the web 30′. The slitters 60 may, for example, comprise rollers or knives. The adjacent webs 30 are then wound on axially aligned rolls 32 in the rewinding station 48. Instead of or in addition to the slitters 60, folders may be provided to fold the web in a V-fold or C-fold. This feature would provide the advantage of providing a tablecloth that is wider than the axial length of the roll 32, negating the need to apply the tablecloth 10 in multiple strips 12. In this case, a release liner should be applied to the web 30′ downstream from the adhesive application station 46 to prevent the facing adhesive-bearing surfaces of the folded web from sticking to each other.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept. Some of the changes are discussed above. The scope of still other changes to the described embodiments that fall within the present invention but that are not specifically discussed above will become apparent from the appended claims.

We claim:

1. A self adhering cover, comprising:
a. a substrate capable of being wound onto a roll and unwound from the roll; and
b. an adhesive applied to a bottom surface of the substrate, the adhesive being sufficiently tacky to adhere to a cover.

2. The cover as recited in claim 1, wherein the cover is a tablecloth.

3. The cover as recited in claim 1, wherein the cover comprises multiple strips of the adhesive coated substrate

4. A method of making a self adhesive cover comprising coating a surface of a windable substrate with adhesive.

5. A method comprising:
(A) unwinding a strip of a substrate from a roll, the substrate having adhesive on a surface thereof;
(B) detaching the strip from the roll, and
(C) pressing the adhesive-coated surface of the strip onto a surface of the article.
